(19) United States
(12) Patent Application Publication
(10) Pub. No.: US 2017/0184138 A1
(43) Pub. Date: Jun. 29, 2017

(54) SYSTEM AND METHOD FOR HEALTH MONITORING OF HYDRAULIC SYSTEMS

(71) Applicant: Sikorsky Aircraft Corporation, Stratford, CT (US)

(72) Inventors: Matthew J. Smith, Rochester, NY (US); Jared Kloda, Warriors Mark, PA (US); Jason Friel, Milwaukee, WI (US); Eric Hettler, Rochester, NY (US)

(21) Appl. No.: 15/300,681

(22) PCT Filed: Apr. 1, 2015
(86) PCT No.: PCT/US15/23830

§ 371 Date: Sep. 29, 2016

Related U.S. Application Data
(60) Provisional application No. 61/974,025, filed on Apr. 2, 2014.

(51) Int. Cl. F15B 20/00; G05B 23/02; G01M 3/28

(52) U.S. Cl. CPC F15B 20/005; G01M 3/28; G05B 23/0283

(57) ABSTRACT

A method of health monitoring of a hydraulic system includes measuring a hydraulic fluid level at a first location in the hydraulic systems and measuring one or more of hydraulic fluid pressure and hydraulic fluid temperature at one or more second locations in the hydraulic system. A snap-shot of data is identified that meets a mode detection criteria a model requires to estimate the hydraulic fluid level. An expected hydraulic fluid level is calculated based on the measurements of hydraulic fluid pressure and/or hydraulic fluid temperature, and the expected hydraulic fluid level is compared to the measured hydraulic fluid level, the difference an indicator of leakage in the hydraulic system.

### CROSS-REFERENCE TO RELATED APPLICATIONS

The present application claims priority to U.S. Provisional Application 61/974,025 filed on Apr. 2, 2014, the contents of which are incorporated by reference herein in their entirely.

### FEDERAL RESEARCH STATEMENT

This invention was made with government support with the United States Army under Contract No. W911W6-10-2-0006. The government therefore has certain rights in this invention.

### BACKGROUND

The subject matter disclosed herein generally relates to health monitoring of aircraft. More specifically, the subject disclosure relates to health assessment of hydraulic systems of an aircraft.

A leading driver of maintenance for hydraulic flight control systems is fluid leakage. This includes both external leakage that drains fluid from the stored supply, and internal leakage that reduces component efficiency and degrades system response. Current generation aircraft generally include a Leak Detection and Isolation (LDI) system that is targeted at severe leak conditions that compromise system safety. Generally speaking if the LDI system can observe the leak, enough fluid has been lost that the affected components or system lines need to be isolated by valves and backup systems engaged as required to restore aircraft control. Typically this also results in aborting the mission and landing the aircraft.

The available information upon which to make decisions about hydraulic component replacement and hydraulic system servicing is currently very limited. The flight control systems on legacy aircraft are not well instrumented and leaks are generally diagnosed by visual inspection and ground check tests. Due to a limited understanding of how leak conditions affect actual system performance, maintenance practice is very conservative and component replacement may be performed before it is needed. With a better understanding of leak size, location and progression, more informed decisions can be made about component service and replacement, maintenance logistics, and hydraulic system servicing.

### BRIEF SUMMARY

In one embodiment, a method of health monitoring of a hydraulic system includes measuring a hydraulic fluid level at a first location in the hydraulic systems and measuring one or more of hydraulic fluid pressure and hydraulic fluid temperature at one or more second locations in the hydraulic system. A snapshot of data is identified that meets a mode detection criteria a model requires to estimate the hydraulic fluid level. An expected hydraulic fluid level is calculated based on the measurements of hydraulic fluid pressure and/or hydraulic fluid temperature, and the expected hydraulic fluid level is compared to the measured hydraulic fluid level, the difference an indicator of leakage in the hydraulic system.

Additionally or alternatively, in this or other embodiments the hydraulic fluid level is measured at a hydraulic fluid reservoir of the hydraulic system.

Additionally or alternatively, in this or other embodiments the measured hydraulic fluid pressures and/or hydraulic fluid temperatures are compared to expected hydraulic fluid pressures and/or temperatures and results of the comparison are utilized to isolate a location of leakage in the hydraulic system.

Additionally or alternatively, in this or other embodiments the hydraulic fluid level is measured at a cold start condition and the measured hydraulic fluid level is compared to previous measurements of the hydraulic fluid level.

Additionally or alternatively, in this or other embodiments an estimated leakage rate is calculated based on the comparison of cold start measurements.

Additionally or alternatively, in this or other embodiments the estimated leakage rate is utilized to determine a service interval for the hydraulic system and a change in the leakage rate over a defined time interval.

In another embodiment, a hydraulic system for an aircraft includes a hydraulic fluid reservoir and a plurality of hydraulic actuators operably connected to one or more aircraft components to affect motion of the one or more aircraft components. A plurality of hydraulic lines transmit hydraulic fluid from the hydraulic fluid reservoir to the plurality of hydraulic actuators. A hydraulic diagnostic system includes a hydraulic fluid level sensor and a plurality of hydraulic fluid temperature and/or hydraulic fluid pressure sensors located at the hydraulic system. Thee hydraulic diagnostic system is configured to utilize the measured hydraulic fluid pressure and/or hydraulic fluid temperature to calculate an expected hydraulic fluid level and compare the expected hydraulic fluid level to the measured hydraulic fluid level, the difference an indicator of leakage in the hydraulic system.

Additionally or alternatively, in this or other embodiments the hydraulic fluid level sensor is located at the hydraulic fluid reservoir of the hydraulic system.

Additionally or alternatively, in this or other embodiments the hydraulic diagnostic system is further configured to compare the measured hydraulic fluid pressures and/or hydraulic fluid temperatures to expected hydraulic fluid pressures and/or temperatures, and utilize results of the comparison to isolate a location of leakage in the hydraulic system.

Additionally or alternatively, in this or other embodiments the hydraulic diagnostic system is further configured to measure the hydraulic fluid level at a cold start condition, and compare the measured hydraulic fluid level to previous measurements of the hydraulic fluid level.

Additionally or alternatively, in this or other embodiments the hydraulic diagnostic system is further configured to calculate an estimated leakage rate based on the comparison.

Additionally or alternatively, in this or other embodiments the hydraulic diagnostic system is further configured to utilize the estimated leakage rate to determine a service interval for the hydraulic system.

Additionally or alternatively, in this or other embodiments the hydraulic diagnostic system is located entirely onboard the aircraft.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an illustration of an embodiment of an aircraft;

FIG. 2 is an illustration of an embodiment of a hydraulic system for an aircraft; and

FIG. 3 is a schematic illustration of a leak diagnostic system for a hydraulic system.

The detailed description explains embodiments of the invention, together with advantages and features, by way of example with reference to the drawings.

### DETAILED DESCRIPTION

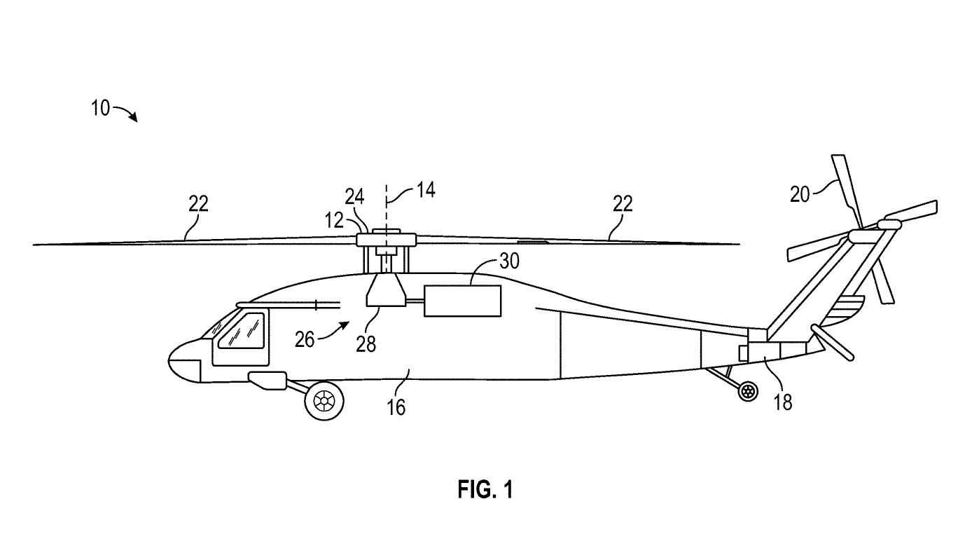

FIG. 1 illustrates an exemplary rotary-winged aircraft 10 having a main rotor system 12, which rotates about a rotor axis 14. The aircraft 10 includes an airframe 16 which supports the main rotor system 12 as well as an extending tail 18 including a tail rotor 20. The main rotor system 12 includes a plurality of rotor blade assemblies 22 mounted to a rotor hub assembly 24. The main rotor system 12 is driven by a transmission 26. The transmission 26 includes a main gearbox 28 driven by one or more engines, illustrated schematically at 30. The main gearbox 28 and engines 30 are considered as part of the non-rotating frame of the aircraft 10. In the case of a rotary wing aircraft, the main gearbox 28 may be interposed between one or more gas turbine engines 30 and the main rotor system 12. Although a particular rotary wing aircraft configuration is illustrated and described in the disclosed non-limiting embodiment, other configurations and/or machines with rotor systems are within the scope of the present invention. Further, one skilled in the art will readily appreciate that the present disclosure may be utilized in other, non-rotary winged aircraft and non-aircraft applications. It is to be appreciated that while the description herein relates to a rotary wing aircraft, the disclosure herein may be as readily applied to aircraft or structures.

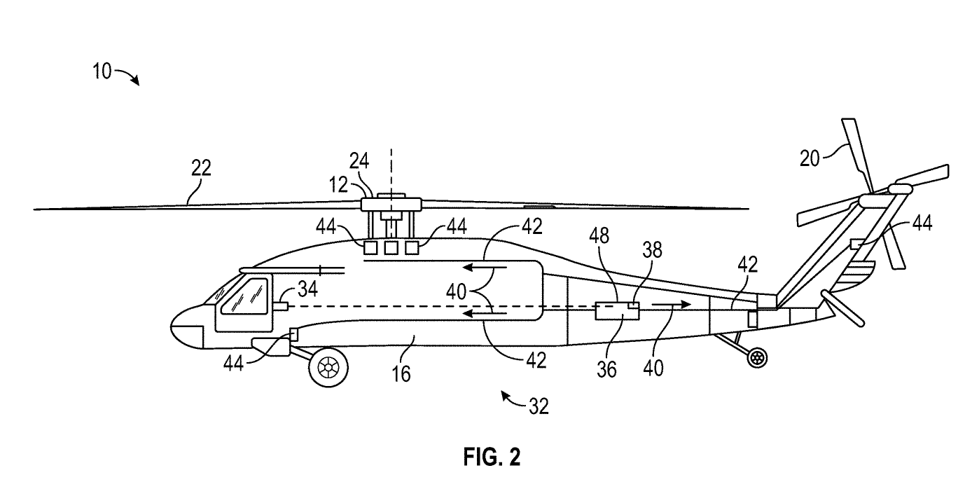

The aircraft 10 includes a hydraulic system 32 operably connected to a flight control system 34 of the aircraft 10, as schematically illustrated in FIG. 2. The hydraulic system 32 includes a hydraulic fluid reservoir 36 and pump 38 to urge a flow of hydraulic fluid 40 to and from the reservoir 36 through a plurality of hydraulic fluid lines 42. The hydraulic fluid lines 42 connect the reservoir 36 to hydraulic actuators 44, which control motion of aircraft components, such as rotor blade pitch adjustment, ailerons, landing gear and/or other components. Hydraulic systems 32 are often prone to leakage, and it is desired to have a greater understanding of hydraulic fluid leakage and its relationship to aircraft performance in order to better service the hydraulic system.

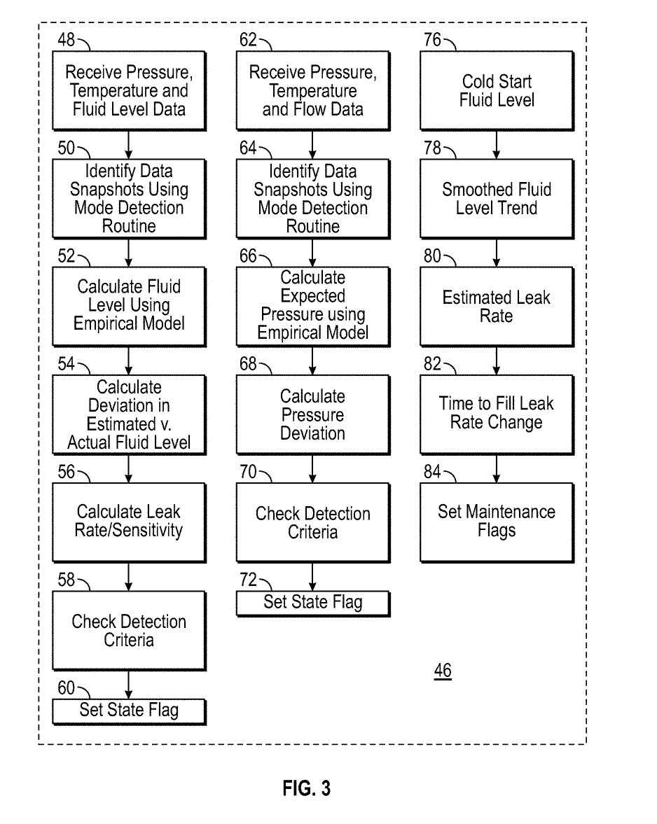

To this end, the aircraft 10 includes a hydraulic diagnostic system 46 (shown in FIG. 3) operably connected to the hydraulic system 32. The hydraulic diagnostic system 46 detects and assesses severity of hydraulic fluid leakage from the hydraulic system 32. Further the hydraulic diagnostic system 46 isolates a location of a detected external leak and assesses hydraulic fluid level trends over time to target slow leak conditions.

An embodiment of the hydraulic diagnostic system 46 is shown schematically in FIG. 3. A first portion of the hydraulic diagnostic system 46 is focused on on-aircraft detection and severity analysis of leakage from the hydraulic system 32. This portion is concerned with leakage that may pose a threat within the current flight, and/or within the next several flights. The hydraulic diagnostic system 46 utilizes sensors 48 (shown in FIG. 2) located in the hydraulic system 32, for example, at the reservoir 36. The sensors 48 measure parameters such as fluid level in the reservoir 36, temperature and/or pressure of the hydraulic fluid 40, and flow volume of hydraulic fluid 40 within the hydraulic system 32. Using this information, a mode detection routine 50 is used to define snapshots of data suitable for estimating fluid leakage. In some embodiments, snapshots of data include data captured in discreet time windows over which a temperature distribution is consistent and stable. Data contained within these windows are then consumed by a predictive fluid level model 52 to determine an expected fluid level at the reservoir 36. The expected fluid level is compared to an actual fluid level 54 at the reservoir 36, with the difference indicating a change in hydraulic fluid level in the hydraulic system 32. The level difference is used to calculate a leak rate 56 or leak severity, with a larger leak rate 56 being, in most instances, of greater severity. The hydraulic diagnostic system 46 checks the leak rate 56 against a set of detection criteria 58 to set an appropriate state flag 60.

In some embodiments, the hydraulic diagnostic system 46 further takes steps to determine a location of the leakage in the hydraulic system 32. Distributed pressure and temperature sensors 62, located throughout the hydraulic system 32 are used to measure temperature and pressure of the hydraulic fluid 40 at these locations. Data snapshots 64 are identified that are suitable for diagnostic input. At block 66, the measured temperatures and flow are used to predict pressures, and the predicted pressures are compared to measured pressures resulting in a pressure deviation 68. At block 70, pressure deviations 68 are utilized to identify patterns that are indicative of leakage in a particular portion of the hydraulic system 32. State flags associated with specific hydraulic system leak locations are set at block 72.

Finally, a third portion of the hydraulic diagnostic system 46 targets slow leakage that may not be observable over a single flight. This portion of the hydraulic diagnostic system 46 may be ground-based, but in other embodiments may be located on the aircraft 10. The slow leakage detector utilizes cold-start hydraulic fluid level measurements 76 and calculates a smoothed hydraulic fluid level history 78 that reduces the fluctuations due to changes in temperature. An estimated leakage rate 80 is then calculated from the smoothed level measurements 78. The estimated leakage rate 80 is utilized to determine service intervals for refill of the reservoir, and detects any changes in the leakage rate over a defined time interval 82, which may be indicative of further fault in the hydraulic system 32. This information is used to set the values for maintenance flags 84 that indicate when the reservoir should be refilled or when an inspection should be performed.

The hydraulic diagnostic system 46 of the present disclosure provides high value condition and health information to hydraulic system 32 maintainers and aircraft operators. It reduces the incidence of unnecessary component removals and system inspections, provides determination of potential leak locations to aid in fault diagnosis, and aids in establishing realistic—i.e., more appropriately timed—service intervals for the hydraulic system 32.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of health monitoring of a hydraulic system comprising:
measuring a hydraulic fluid level at a first location in the hydraulic systems;
measuring one or more of hydraulic fluid pressure and hydraulic fluid temperature at one or more second locations in the hydraulic system;
identifying a snapshot of data that meets a mode detection criteria a model requires to estimate the hydraulic fluid level;
calculating an expected hydraulic fluid level based on the measurements of hydraulic fluid pressure and/or hydraulic fluid temperature; and
comparing the expected hydraulic fluid level to the measured hydraulic fluid level, the difference an indicator of leakage in the hydraulic system.

2. The method of claim 1, wherein the hydraulic fluid level is measured at a hydraulic fluid reservoir of the hydraulic system.

3. The method of claim 1, further comprising:
comparing the measured hydraulic fluid pressures and/or hydraulic fluid temperatures to expected hydraulic fluid pressures and/or temperatures; and
utilizing results of the comparison to isolate a location of leakage in the hydraulic system.

4. The method of claim 1, further comprising:
measuring the hydraulic fluid level at a cold start condition; and
comparing the measured hydraulic fluid level to previous measurements of the hydraulic fluid level.

5. The method of claim 4, further comprising calculating an estimated leakage rate based on the comparison.

6. The method of claim 5, further comprising utilizing the estimated leakage rate to determine a service interval for the hydraulic system and a change in the leakage rate over a defined time interval.

7. A hydraulic system for an aircraft comprising:
a hydraulic fluid reservoir;
a plurality of hydraulic actuators operably connected to one or more aircraft components to affect motion of the one or more aircraft components;
a plurality of hydraulic lines to transmit hydraulic fluid from the hydraulic fluid reservoir to the plurality of hydraulic actuators; and
a hydraulic diagnostic system including:
a hydraulic fluid level sensor; and
a plurality of hydraulic fluid temperature and/or hydraulic fluid pressure sensors located at the hydraulic system;
wherein the hydraulic diagnostic system is configured to utilize the measured hydraulic fluid pressure and/or hydraulic fluid temperature to calculate an expected hydraulic fluid level and compare the expected hydraulic fluid level to the measured hydraulic fluid level, the difference an indicator of leakage in the hydraulic system.

8. The hydraulic system of claim 7, wherein the hydraulic fluid level sensor is located at the hydraulic fluid reservoir of the hydraulic system.

9. The hydraulic system of claim 7, wherein the hydraulic diagnostic system is further configured to:
compare the measured hydraulic fluid pressures and/or hydraulic fluid temperatures to expected hydraulic fluid pressures and/or temperatures; and
utilize results of the comparison to isolate a location of leakage in the hydraulic system.

10. The hydraulic system of any of claims 7, wherein the hydraulic diagnostic system is further configured to:
measure the hydraulic fluid level at a cold start condition; and
compare the measured hydraulic fluid level to previous measurements of the hydraulic fluid level.

11. The hydraulic system of claim 10, wherein the hydraulic diagnostic system is further configured to calculate an estimated leakage rate based on the comparison.

12. The hydraulic system of claim 11, wherein the hydraulic diagnostic system is further configured to utilize the estimated leakage rate to determine a service interval for the hydraulic system.

13. The hydraulic system of claim 7, wherein the hydraulic diagnostic system is located entirely onboard the aircraft.
